(19) United States
(12) Patent Application Publication
(10) Pub. No.: US 2019/0093047 A1
(43) Pub. Date: Mar. 28, 2019

(54) EMULSION COMPOSITION AND POWDER COMPOSITION

(71) Applicant: T. HASEGAWA CO., LTD., Tokyo (JP)

(72) Inventors: Shogo YOSHIDA, Kawasaki-shi (JP); Yasutaka OHKUBO, Kawasaki-shi (JP); Yui MASUDA, Kawasaki-shi (JP); Shogo MURASAWA, Kawasaki-shi (JP); Kazuya KAWABATA, Kawasaki-shi (JP)

(21) Appl. No.: 16/145,500

(22) Filed: Sep. 28, 2018

Related U.S. Application Data
(63) Continuation of application No. PCT/JP2017/009371, filed on Mar. 9, 2017.

(30) Foreign Application Priority Data
Apr. 1, 2016 (JP) 2016-074574

(51) Int. Cl. C11B 9/00; A23L 29/10; A23L 27/00; A23L 2/38; A23G 4/06; A23L 2/56; A23L 27/20

(52) U.S. Cl. CPC C11B 9/0034; A23L 29/10; A23L 27/88; A23V 2002/00; A23G 4/06; A23L 2/56; A23L 27/204; A23L 2/38

(57) ABSTRACT

An emulsion composition containing menthyl ethers represented by the formula (1) or a power composition prepared by drying such an emulsion composition can provide an emulsion composition and a powder composition which can be readily incorporated in food and drink or perfumery and has a fresh and mild bitterness (a naringin-like bitterness) with slow bitterness rising;

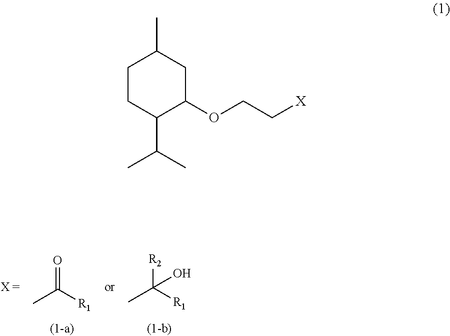

in the formula (1), X represents a partial structural formula (1-a) or (1-b), and R₁ and R₂ each represent a methyl group, an ethyl group, a propyl group or an isopropyl group.

This application is a Continuation of PCT International Application No. PCT/JP2017/009371, filed on Mar. 9, 2017, which claims priority under 35 U.S.C. Section 119(a) to Japanese Patent Application No. 2016-074574 filed on Apr. 1, 2016. Each of the above applications is hereby expressly incorporated by reference, in its entirety, into the present application.

### BACKGROUND OF THE INVENTION

### Technical Field of the Invention

The present invention relates to an emulsion composition and a powder composition containing a specific menthyl ether, which have a specific aroma and a bitter taste and are useful as an aroma imparter or aroma modulator or a bitterness-imparting flavor modulator. The present invention also relates to food and drink or perfumery containing any of these emulsion composition and powder composition. Further, the present invention relates to an aroma imparting or aroma modulating method for food and drink or perfumery and a bitterness imparting method for food and drink, using any of these emulsion composition and powder composition.

### Background Art

Humans take an energy source from food, stay fit by eating, and receive satisfaction with delicious meals and good textures, and eating plays an important role on human life. It is said that a pleasant taste of food is derived from nutrient components such as carbohydrates and fats of food and drink and the taste and the flavor of food and drink are important elements. A sense of taste to be perceived by mouth and a sense of smell to be perceived by nose are independent senses, but in recent studies, it is said that a sense of taste and a sense of smell are integrated in the brain in eating and drinking and are recognized as a pleasant taste and a satisfaction in eating.

Regarding the aroma of food and drink, an orthonasal smell of an aroma to be breathed by a nose and greeted by the mucous membrane will be important but it is said that a retronasal smell of an aroma to run from a throat through a nose by the stimulation of the taste of food and drink to a mouth is the most important.

Heretofore, compounds that stimulate a sense of smell and also stimulate a sense of taste at the same time are known as odorous materials. Menthol known as a typical example of such compounds has a powerful cooling aroma and a feeling of stimulation to be given to a mucous membrane, and is widely used in a variety of food and drink or perfumery. At the same time, regarding the sense of taste thereof, menthol is known to have a peculiar bitter taste. In the case where menthol is used, such properties thereof could be in favor of or not in favor of the targeted food and drink or perfumery.

For example, in the case where menthol is used in food and drink for the purpose of imparting a pleasant cooling sensation thereto, some disadvantages thereof are pointed out in that, since menthol is highly volatile, the pleasant cooling sensation thereof could not last long, and menthol has a peculiar bitter taste. Accordingly, a number of masking methods for overcoming the defective bitterness of menthol have been proposed. As one example, use of glycidates that are used as aroma chemicals as a bitterness masking agent is disclosed (Patent Document 1).

On the other hand, an attempt to change the chemical structure of menthol for the purpose of making the pleasant cooling sensation thereof last and at the same time for suppressing the bitterness thereof has been made widely, and useful derivatives have been synthesized. Compounds developed and synthesized for the purpose include ester derivatives utilizing the hydroxyl group of menthol, and paramenthane-carboxylic acid derivatives with a carboxylic acid introduced into the menthol-constituting carbon skeleton. As more specific compounds, there are known menthyl 3-hydroxybutyrate, menthol glycerin ester (Cooolact 10, registered trademark of Takasago International Corporation, Patent Document 2), menthyl lactate (Frescolate ML, registered trademark of Symrise AG), monomenthyl succinate (Physcool, registered trademark of V. Mane Fils SA), N-ethyl-p-menthanecarboxamide (WS-3), ethyl 2-[(5-methyl-2-propan-2-ylcyclohexanecarbonyl)amino] acetate (WS-5), N-(4-methoxyphenyl)-p-menthanecarboxamide (WS-12), and N,2,3-trimethyl-2-isopropylbutanamide (WS-23) (Patent Document 3). These compounds are characterized by having a freshening aroma and a long-lasting pleasant cooling sensation with no bitterness, and are therefore used in various products either alone as individual compounds or as combined with menthol.

On the other hand, bitterness is an important constituent element to express the characteristic features of food, and bittering components include tannin contained in astringent persimmon, wine, etc., catechin contained in tea, chlorogenic acid contained in coffee, and alpha acids contained in hop and characterizing the bitterness of beer. These components have a bitterness peculiar to each, and are recognized to be compounds important in constituting food and drink containing them (Non-Patent Document 1). However, naturally-occurring bittering materials have a flavor intrinsic to raw materials-derived natural substances in addition to the peculiar bitterness thereof, and application thereof to general food and drink is limited. Given the situation, development of compounds not having a flavor intrinsic to raw materials-derived natural substances but having a good bitterness is desired.

There are known few examples of applying stimulation and bitterness peculiar to menthol, and only a case of adding menthol for the purpose of preventing drug abuse is disclosed (Patent Document 4). In addition, since menthol has a strong cooling aroma, it has heretofore been difficult to incorporate it in general food and drink for imparting bitterness thereto. For overcoming this drawback, there is not known an attempt to study menthol derivatives for the purpose of pursuing the bitterness peculiar to menthol as a good bitterness and at the same time for suppressing the strong cooling aroma of menthol.

### PRIOR ART DOCUMENT

### Patent Document

### Patent Document 1: JP 5198533 B

### Patent Document 2: JPS58-88334 A

### Patent Document 3: JPS47-16648

### Patent Document 4: JP 2005-500364 A

### Non-Patent Document

### Non-Patent Document 1: Yasumasa Yamada, “New Food Industry”, 2002, Vol. 44, No. 2, pp. 49-55

### SUMMARY OF INVENTION

Accordingly and in consideration of the above-mentioned problems, the present inventors have assiduously studied for providing a flavor modulator containing, as an active ingredient, a menthol derivative having a bitterness with no unpleasant taste and capable of suppressing a cooling sensation and a refreshing feel, and as a result, have found that specific menthyl ethers such as 2-methyl-4-menthyloxy-2-butanol are useful, and have previously filed a patent application thereon (JP 2016-84418A).

These compounds can suppress a cooling sensation and a refreshing feel that are often given by menthol and derivatives thereof, and can have an aroma of relatively woody, spicy and herbal sensation and a long-lasting good bitterness with no unpleasant taste. However, for incorporating such a compound in food and drink for imparting bitterness thereto, it is desired to slow the rising of bitterness and to provide a fresher and milder bitterness thereby attaining a better balance with sweetness and sourness in food and drink. In addition, these menthyl ethers are oil-soluble ones, and therefore when incorporated in water-rich food, there occur problems in that they could hardly mix therein uniformly and would separate during storage.

Accordingly, a problem to be solved by the invention is to provide an emulsion composition and a powder composition which can be readily incorporated in food and drink or perfumery and has a fresh and mild bitterness with slow bitterness rising.

The present inventors have further made assiduous studies relating to specific menthyl ethers such as 4-menthyloxy-2-butanone, and as a result, have found that an emulsion composition containing a specific menthyl ether or a powder composition prepared by drying such an emulsion composition can be readily incorporated in food and drink or perfumery and, especially when added to food and drink, the emulsion composition or the powder composition can provide a fresher and milder bitterness while slowing the rising of the bitterness and while maintaining sharp bitterness characteristics, as compared with the compounds not in a state of an emulsion composition or a powder composition, and have completed the present invention. In addition, the present inventors have further found that, when an oil or fat is incorporated in the emulsion composition, the bitterness can last for a longer period of time.

4-Menthyloxy-2-butanone disclosed as menthyl ethers in the present invention is a compound synthesized in studies of organic chemistry, but there is no report relating to the flavor of the compound and also derivatives thereof (Tetrahedron Lett., 47, 2905 (2006)).

With that, the present invention provides the following:

[1] An emulsion composition containing the following (A) to (D).
(A) A menthyl ether represented by the following formula (1),

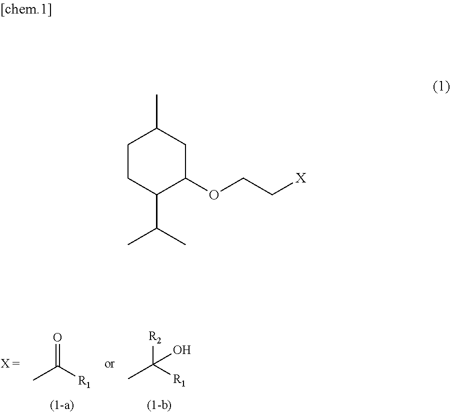

[in the formula (1), X represents a partial structural formula (1-a) or (1-b), and R₁ and R₂ each represent a methyl group, an ethyl group, a propyl group or an isopropyl group.]

### (B) Water,

(C) One or more selected from saccharides, monoalcohols or polyalcohols,
(D) An emulsifier.
[2] The emulsion composition according to [1], further containing (E) an edible oil or fat.
[3] The emulsion composition according to [1] or [2], wherein the menthyl ether is 2-methyl-4-menthyloxy-2-butanol represented by the following formula (2).

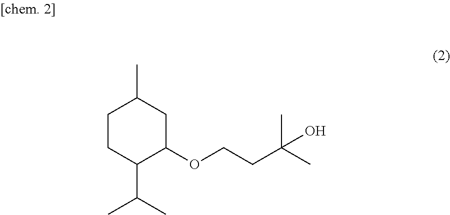 [SMILES: CC1CCC(C(C)C)C(OCCC(C)(C)O)C1]

[4] A powder composition prepared by drying the emulsion composition of any one of [1] to [3].
[5] Food and drink containing the emulsion composition of any one of [1] to [3] or the powder composition of [4].
[6] Perfumery containing the emulsion composition of any one of [1] to [3] or the powder composition of [4].
[7] A flavor-imparting or flavor-modulating method for food and drink or perfumery, which comprises adding thereto the emulsion composition of any one of [1] to [3] or the powder composition of [4].
[8] A bitterness imparting method for food and drink, which comprises adding thereto the emulsion composition of any one of [1] to [3] or the powder composition of [4].

The emulsion composition or the power composition containing a specific menthyl ether has a good and sharp bitterness with no unpleasant taste and, as compared with the unemulsified menthyl ethers mentioned above, can slow the rising of bitterness and can provide a fresher and mild bitterness. As a result, the emulsion composition or the power composition can impart a bitterness that may conjure the bitterness of citrus fruits like that of naringin.

In a preferred embodiment of the present invention, the emulsion composition or the power composition containing a specific menthyl ether of the present invention has a slight cooling sensation and refreshing feeling, and a somewhat woody, spicy and herbal aroma.

In a preferred embodiment of the present invention, an oil or fat is incorporated in the emulsion composition in which the bitterness peculiar to the menthyl ether can last for a longer period of time. By incorporating the emulsion composition or the powder composition of the present invention in perfumery or food and drink as an aroma imparter or an aroma modulator or as a bitterness-imparting flavor modulator thereby using the aroma and the good bitterness thereof, it has become possible to develop food and drink having a heretofore unknown novel flavor, and it has become possible to expand a novel application range for the emulsion composition or the powder composition.

### DESCRIPTION OF EMBODIMENTS

The present invention relates to an emulsion composition and a powder composition containing (A) a menthyl ether represented by the formula (1), (B) water, (C) one or more selected from saccharides, monoalcohols or polyalcohols, and (D) an emulsifier. Not emulsified and by itself, the menthyl ether represented by the formula (1) has an effect as an aroma imparter or an aroma modulator, a bitterness-imparting flavor modular, a pleasant cooling sensation imparter, and a bitterness imparter, and is useful. The wording “or” in “an aroma imparter or an aroma modulator” has the same meaning as a wording “and/or”.

However, when formed into an emulsion composition and a powder composition containing (A) a menthyl ether represented by the formula (1), (B) water, (C) one or more selected from saccharides, monoalcohols or polyalcohols and (D) an emulsifier, the dispersibility of the menthyl ether in water can be bettered and therefore the menthyl ether can be more readily incorporated in food and drink or perfumery, and in addition, bitterness rising can be slowed to provide a fresher and milder bitterness. If desired, an edible oil or fat may be incorporated in the emulsion composition and the content of the edible oil or fat may be increased whereby the bitterness of the menthyl ether therein can last for a longer period of time. Preferably, the emulsion composition of the powder composition containing the menthyl ether represented by the formula (1) is stable during storage.

For example, in the case where 2-methyl-4-menthyloxy-2-butanol is incorporated in a grapefruit-like flavor-having drink for the purpose of imparting aroma and bitterness thereto and when the compound is incorporated in an oil-soluble aroma chemical and then added to the drink, the oil-soluble aroma chemical floats in oil and 2-methyl-4-menthyloxy-2-butanol contained in the oil directly acts in the mouth. On the other hand, when the compound is formed in a stage of an emulsion composition therein, fine particles of 2-methyl-4-menthyloxy-2-butanol may uniformly act in the mouth. As a result, it becomes possible to impart a more grapefruit-like bitterness.

Of the menthyl ether in a state of the emulsion composition or the powder composition of the present invention, the rising of bitterness is slow as compared with that of an unemulsified menthyl ether, and accordingly, the menthyl ether in the emulsion composition or the powder composition can be felt to provide a fresher and milder bitterness.

Specifically, the menthyl ethers represented by the formula (1) for use in the emulsion composition or the powder composition of the present invention include, though not limited thereto, 4-menthyloxyalkyl ketones represented by the formula (3), for example, 4-menthyloxy-2-butanone. Also not limited thereto, the menthyl ethers for use herein include alkyl-4-menthyloxyalkanols represented by the formula (4), for example, 2-methyl-4-menthyloxy-2-butanol represented by the formula (2). In the formula (1), R₁ and R₂ each independently represent a methyl group, an ethyl group, a propyl group or an isopropyl group, and they may be the same as or different from each other. R₁ and R₂ each are preferably a methyl group.

For obtaining the menthyl ethers represented by the formula (1), a 4-menthyloxyalkyl ketone represented by the formula (3) is synthesized in the step (1) according to the reaction formula 1 mentioned below, and then an alkyl-4-menthyloxyalkanol represented by the formula (4) is synthesized in the step (2).

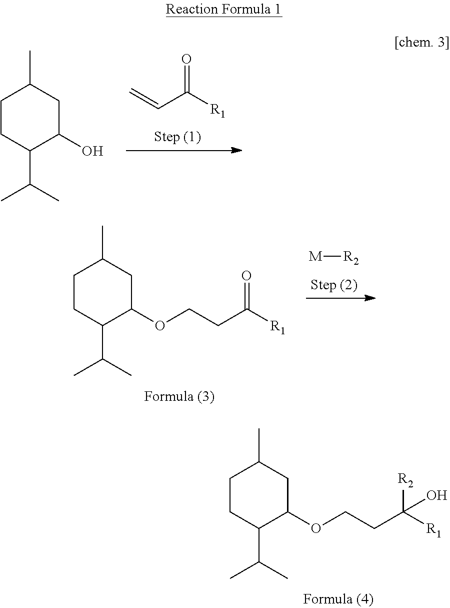

In the reaction formula 1: [R₁ and R₂ each represent a methyl group, an ethyl group, a propyl group or an isopropyl group. M represents Li or MgX, and X represents a halogen atom.]

An outline of each step in the reaction formula 1 is described. In the step (1), menthol is reacted with an alkylvinyl ketone in the presence of a catalyst as a Michael addition reaction to synthesize the 4-menthyloxyalkyl ketone represented by the formula (3). In the step (2), the 4-menthyloxyalkyl ketone represented by the formula (3) obtained in the step (1) is reacted with an alkyl metal reagent to synthesize an alkyl-4-menthyloxyalkanol represented by the formula (4).

Hereinunder the step (1) and the step (2) are described in detail. Menthol (2-isopropyl-5-methylcyclohexanol) used as the raw material in the step (1) includes 8 isomers and among them, use of a naturally occurring type of 1-menthol having an excellent aroma is desirable though not limited thereto. The other reaction block of an alkyl vinyl ketone is 3-buten-2-one (methyl vinyl ketone), 1-penten-3-one (ethyl vinyl ketone), 1-hexen-3-one (propyl vinyl ketone) or 4-methyl-1-penten-3-one (isopropyl vinyl ketone), and all are available on the market or can be synthesized according to known methods for use herein.

Not specifically limited, the alkyl vinyl ketone for use in the reaction of the step (1) may be in an equivalent amount or more relative to menthol, but from the viewpoint of economical aspect, the amount thereof may be 1.5 equivalents to 5 equivalents, preferably 2 equivalents to 4 equivalents.

Use of a catalyst in the Michael addition reaction is effective, and an acidic or a basic catalyst can be used. Examples of the acidic catalyst include Broensted acids such as sulfuric acid, hydrochloric acid, phosphoric acid, and paratoluenesulfonic acid, and use of paratoluenesulfonic acid is preferred. The acidic catalyst also includes Lewis acid catalysts such as boron trifluoride ether complex, titanium tetrachloride, and aluminum trichloride, and use of boron trifluoride ether complex is preferred. A basic catalyst is also usable, and tertiary amines and quaternary alkylammonium hydroxides are usable.

The reaction of the step (1) may go on in the absence of a solvent, but a solvent may also be used therein. A solvent inert to the reaction raw materials menthol and alkyl vinyl ketone and to the catalyst used is preferred. Use of a hydrocarbon solvent such as toluene, heptane or hexane, an ether solvent such as diethyl ether, or a chlorine solvent such as methylene chloride is preferred, and use of a chlorine solvent such as methylene chloride is more preferred.

The reaction temperature is influenced by the amount and/or the activity of the catalyst used and by the solvent used, and the reaction condition is preferably −78° C. to 50° C., more preferably 0° C. to 30° C. The reaction time is influenced by the amount and/or the activity of the catalyst used and by the solvent used, and may be a few hours to a few days though not specifically limited thereto. The reaction time may be determined with monitoring the reaction progress through gas chromatography or thin-layer chromatography. The 4-menthyloxyalkyl ketone represented by the formula (3) obtained in the step (1) may be purified, if desired, according to a means of column chromatography, reduced-pressure distillation, etc.

In the step (2), an alkyl-4-menthyloxyalkanol represented by the formula (4) is synthesized through addition reaction of an alkyl metal reagent to the carbonyl group of the 4-menthyloxyalkyl ketone represented by the formula (3). An alkali metal compound that reacts with the 4-menthyloxyalkyl ketone represented by the formula (3) includes an alkyl lithium such as methyl lithium, ethyl lithium or propyl lithium, and an alkyl Grignard reagent such as methyl magnesium chloride, methyl magnesium bromide, ethyl magnesium chloride, or ethyl magnesium bromide. These alkyl metal reagents may be available on the market or may be a reagent prepared from the corresponding metal and alkyl halide. The alkyl metal reagent for use in the reaction is preferably in an equimolar amount to 2 molar times, especially 1.05 molar times to 1.5 molar times relative to the 4-menthyloxyalkyl ketone represented by the formula (3).

The reaction solvent to be used depends on the property of the alkyl metal reagent used, and with no specific limitation thereon, the solvent may be any one that is inert to the alkyl metal reagent used and can dissolve the alkyl metal reagent and also can dissolve the reaction substrate, 4-menthyloxyalkyl ketone represented by the formula (3). For example, use of diethyl ether, methyl tertiary butyl ether, tetrahydrofuran or 1,4-dioxane is preferred.

The reaction condition is influenced by the property of the alkyl metal reagent used, and in general, since the reaction of the carbonyl compound and the alkyl metal reagent is exothermic reaction and is influenced by the water content in the solvent and also by the oxygen having dissolved in the atmosphere or in the solvent, it is desirable that the reaction is carried out under the condition capable of evading these influences. Preferably, the reaction is carried out in a nitrogen atmosphere and/or using a dewatered solvent.

The reaction temperature is influenced by the type of the alkyl metal reagent used and the solvent used, and is preferably −78° C. to 40° C., more preferably 0° C. to 30° C. The reaction time is influenced by the type of the alkyl metal reagent used and the solvent used, and the reaction may end in a few hours. Preferably, the reaction time is determined with monitoring the reaction progress through gas chromatography, thin-layer chromatography, etc. Preferably, the alkyl-4-menthyloxyalkanol represented by the formula (4) obtained in the step (2) is optionally purified according to a means of column chromatography, reduced-pressure distillation, etc.

Two or more different kinds of the menthyl ethers represented by the formula (1) may be mixed in any ratio and used in the emulsion composition of the present invention, and especially when combined with any other cooling sensation sustainer, these may exhibit an effect of sustaining a cooling sensation and relieving the bitterness of menthol.

For the emulsion composition containing a menthyl ether represented by the formula (1) of the present invention, the menthyl ethers are not specifically limited, and any menthyl ether of the formula (1) emulsified in any known method is employable. For example, in addition to the flavor modulating compound component, menthyl ether represented by the formula (1) as (A), the emulsion composition contains (B) water, (C) one or more selected from saccharides, monoalcohols or polyalcohols, and (D) an emulsifier, and may be obtained by mixing, stirring and emulsifying them.

In emulsifying the components, for example, the menthyl ether represented by the formula (1) of (A) may form an oily phase and (B) water and (C) one or more selected from saccharides, monoalcohols or polyalcohols may form an aqueous phase, and in that manner, an oil-in-water (O/W) emulsion composition may be prepared.

Accordingly, the rising of bitterness of the menthyl ethers represented by the formula (1) can be slowed more to provide a fresher and milder bitterness than that of unemulsified menthyl ethers. The meaning that the rising of bitterness is slow indicates that the bitterness is sensed a bit later than that just taken in the mouth. Bitterness is generally an unpleasant taste, and when a bitter substance is taken in a mouth, it immediately expresses the bitterness to often give an unpleasant feeling in many cases. However, some bitter substances may express a pleasant bitterness. For example, it is said that naringin contained in citrus fruits may present a fresh and mild bitterness in citrus fruits themselves or citrus juices. The emulsion composition of the present invention has a taste similar to the bitterness of naringin in citrus fruits.

In addition, the oily phase may contain (E) an edible oil or fat in addition to the menthyl ethers represented by the formula (1) of (A). An edible oil or fat optionally incorporated in the emulsion composition can sustain the bitterness for a longer period of time. The amount of the edible oil or fat incorporated may have an influence on the bitterness lasting time. Specifically, by increasing the amount of the edible oil or fat to be incorporated, the bitterness lasting time can be prolonged more, but by reducing the amount of the edible oil or fat to be incorporated, the bitterness lasting time can be relatively shortened.

Further, the solvent to dissolve the menthyl ethers represented by the formula (1) (for example, the oily phase) may contain SAIB (sucrose diacetate hexaisobutyrate) as a specific gravity regulator as well as ordinary aroma chemicals as other flavor components than the menthyl ethers represented by the formula (1), in addition to the edible oil or fat.

The edible oil or fat usable as the component (E) is preferably one readily miscible with the menthyl ethers represented by the formula (1), and examples thereof include animal and vegetable oils and fats such as soybean oil, sesame oil, corn oil, rapeseed oil, rice bran oil, cottonseed oil, castor oil, peanut oil, olive oil, palm oil, safflower oil, wheat germ oil, sunflower oil, camellia oil, cocoa fat, sardine oil, salmon oil, mackerel oil, shark oil, tuna oil, whale oil, dolphin oil, squid oil, saury oil, herring oil, cod oil, beef tallow, chicken oil, lard, butter and hydrogenated oils and fats thereof, as well as middle-chain saturated fatty acid triglycerides (hereinafter referred to as MCT). MCT is especially preferred. Examples of such MCT include middle-chain saturated fatty acid triglycerides having 6 to 12 carbon atoms such as caproic triglyceride, caprylic triglyceride, capric triglyceride, lauric triglyceride, and arbitrary mixtures thereof. Among these, caprylic triglyceride, capric triglyceride and arbitrary mixtures thereof are preferred. These MCT mixtures are readily and inexpensively available on the market. The content of edible oil or fat in the emulsion composition of the present invention is not specifically limited but may be generally within a range of 0.01 to 2000 parts by mass relative to 1 part by mass of the menthyl ether represented by the formula (1), preferably 0.1 to 500 parts by mass, more preferably 0.5 to 100 parts by mass, even more preferably 2 to 50 parts by mass.

SAIB (sucrose diacetate hexaisobutyrate) is incorporated for the purpose of controlling the specific gravity of the oily phase in the emulsion composition of the present invention, and in the case where the final product (food and drink, perfumery) in which the emulsion composition of the present invention is incorporated is an aqueous composition, SAIB may be incorporated therein for the purpose of preventing the emulsion composition from separating owing to specific gravity difference.

SAIB usable here is, for example, SAIB having a specific gravity falling within a range of about 1.13 to about 1.19, preferably about 1.14 to about 1.15. The content of SAIB in the emulsion composition of the present invention may be varied depending on the specific gravity of SAIB to be used and the specific gravity of drink in which the emulsion composition is to be incorporated, and in general, the content is preferably such that the difference between the specific gravity of the entire oily phase in the emulsion composition of the present invention and the specific gravity of the aqueous composition of a final product (for example, the food and drink or perfumery of the present invention) in which the emulsion composition of the present invention is incorporated is 0.05 or less, especially 0.03 or less. When the specific gravity difference is 0.05 or less, ring formation or oil floating would hardly occur in the case where the aqueous composition in which the emulsion composition of the present invention is incorporated is stored for a long period of time. The blending ratio of SAIB in the oily phase is, for example, generally within a range of about 0.2 parts by mass to about 0.6 parts by mass relative to 1 part by mass of the entire oily phase including SAIB, preferably about 0.3 parts by mass to about 0.5 parts by mass. However, finally, it is desirable that the SAIB content is experientially found out so as to attain a specific gravity difference of 0.05 or less while measuring the specific gravity of the aqueous composition in which the emulsion composition of the present invention is incorporated and the specific gravity of the oily phase in the emulsion composition.

Examples of various ordinary aroma chemicals that may be the other flavor components than the menthyl ethers represented by the formula (1) (other ordinary aroma chemicals capable of being incorporated along with the menthyl ethers represented by the formula (1)) include, as a cooling sensation sustaining agent, menthyl 3-hydroxybutyrate, menthol glycerin ether (Coolant 10, registered trademark of Takasago International Corporation), menthyl lactate (Frescolate ML, registered trademark of Symrise AG), monomenthyl succinate (Physcool, registered trademark of V. Mane Fils SA), N-ethyl-p-menthanecarboxamide (WS-3), ethyl 2-[(5-methyl-2-propan-2-ylcyclohexanecarbonyl)amino] acetate (WS-5), N-(4-methoxyphenyl)-p-menthanecarboxamide (WS-12), and N,2,3-trimethyl-2-isopropylbutanamide (WS-23).

As other ordinary aroma chemicals than those mentioned above capable of being incorporated along with the menthyl ethers represented by the formula (1), there are mentioned synthetic aroma chemicals, natural essential oils, natural aroma chemicals and animal and vegetable extracts described in “Japan Patent Office, Well-Known and Commonly-Used Arts Collection (aroma chemicals), Part II Food Aroma Chemicals, pp. 8-87, issued Jan. 14, 2000”.

As examples of these aroma chemical components, there are mentioned hydrocarbon compounds including monoterpenes such as α-pinene, β-pinene, myrcene, camphene and limonene; sesquiterpenes such as valencene, cedrene, caryophyllene, and longifolene; and 1,3,5-undecatriene.

The alcohol compounds include linear saturated alcohols such as butanol, pentanol, isoamyl alcohol, and hexanol; linear unsaturated alcohols such as prenol, (Z)-3-hexen-1-ol, and 2,6-nonadienol; terpene alcohols such as linalool, geraniol, citronerol, tetrahydromyrcenol, farnesol, nerolidol, and cedrol; and aromatic alcohols such as benzyl alcohol, phenylethyl alcohol, and furfuryl alcohol.

The aldehyde compounds include aliphatic saturated aldehydes such as acetaldehyde, isovaleraldehyde, hexanal, octanal, nonanal, and decanal; aliphatic unsaturated aldehydes such as (E)-2-hexenal, and 2,4-octadienal; terpene aldehydes such as citronellal, and citral; and aromatic aldehydes such as benzaldehyde, cinnamyl aldehyde, vanillin, ethylvanillin, furfural, and heliotropin.

The ketone compounds include linear saturated or unsaturated ketones such as 2-heptanone, 2-undecanone, and 1-octen-3-one; linear or cyclic diketones such as acetoin, diacetyl, 2,3-pentanedione, maltol, ethylmaltol, and 2,5-dimethyl-4-hydroxy-3(2H)-furanone; terpene ketones such as carbon, menthone, and nootkatone; ketones derived from terpene decomposition products such as α-ionone, β-ionone, and β-damascenone; and aromatic ketones such as raspberry ketone.

The furan ether compounds include cyclic ethers such as rose oxide, linalool oxide, menthofuran, and theaspirane; and aromatic ethers such as methylchavicol, and anethole.

The ester compounds include aliphatic alcohol acetates such as ethyl acetate, and isoamyl acetate; terpene alcohol acetates such as linalyl acetate, geranyl acetate, and lavandulyl acetate; esters of fatty acids and lower alcohols such as ethyl butyrate, and ethyl caproate; and aromatic esters such as benzyl acetate, and methyl salicylate.

The lactone compounds include saturated lactones such as γ-decalactone, γ-dodecalactone, δ-decalactone and δ-dodecalactone; and unsaturated lactones such as 7-decen-4-olide, and 2-decen-5-olide.

The acid compounds include saturated or unsaturated fatty acids such as butyric acid, 4-methyl-3-pentenoic acid, octanoic acid, stearic acid, oleic acid, linolic acid, and linolenic acid.

The nitrogen-containing compounds include indole, skatole, pyridine, alkyl-substituted pyrazine, and methyl anthranilate.

The sulfur-containing compounds include methanethiol, furfurylmercaptan, dimethyl sulfide, dimethyl disulfide, difurfuryl disulfide, and allyl isothiocyanate.

The natural essential oils include sweet orange, bitter orange, petitgrain, lemon, grape fruit, lime, bergamot, mandarin, neroli, peppermint, spearmint, lavender, chamomile, rosemary, eucalyptus, sage, basil, rose, geranium, jasmine, ylang-ylang, anise, fennel, star anise, clove, cinnamon, ginger, nutmeg, cardamom, hop, Japanese cedar, Japanese cypress, vetiver, patchouli, and labdanum.

Various extracts include herb or spice extracts; coffee, green tea, black tea or oolong tea extracts; and milk and milk products and enzymatic decomposition products thereof with lipase or protease.

The emulsion composition containing a menthyl ether represented by the formula (1) may contain, if desired, various components generally used in aroma chemical compositions, for example, solvents such as water and ethanol, and aroma-retaining agents such as ethylene glycol, 1,2-propylene glycol, glycerin, benzyl benzoate, triethyl citrate, fatty acid triglyceride, and fatty acid diglyceride.

Preferably, water of the component (B) for use in the present invention constitutes the above-mentioned aqueous phase along with the component (C) of saccharides, monoalcohols or polyalcohols. The water content in the aqueous phase is generally 50% or less, and especially preferably, the emulsion composition is used in a hydrated state where the water content falls within a range of about 0 to 25%. However, when the water content is more than 50%, the emulsion composition may lose preservative performance.

The component (C) of saccharides, monoalcohols or polyalcohols in the present invention is incorporated for stabilizing emulsion. Examples of the saccharides include glucose, fructose, sucrose, trehalose, cellobiose, maltotriose, rhamnnose, lactose, maltose, ribose, xylose, arabinose, and starch syrup; examples of the monoalcohols include ethanol, propanol, and isopropanol; and examples of the polyalcohols include glycerin, propylene glycol, 1,3-butylene glycol, sorbitol, maltitol, and starch degraded reduced product, and a mixture of two or more of these.

The amount of the aqueous phase in the emulsion composition of the present invention is generally within a range of about 1 part by mass to about 10 parts by mass relative to 1 part by mass of the oily phase therein, and especially preferably within a range of about 1.5 parts by mass to about 5 parts by mass. If desired, an organic acid such as lactic acid, citric acid, malic acid or tartaric acid may be added to the aqueous phase for the purpose of improving the storage stability of the emulsion composition.

The menthyl ethers of the formula (1) of the component (A) and the above-mentioned various aroma chemicals can dissolve in saccharides, monoalcohols or polyalcohols of the component (C) so far as they are in a low concentration, and therefore can be incorporated in the aqueous phase.

As the emulsifier of the component (D) in the present invention, various emulsifiers heretofore generally used in food and drink are usable with no specific limitation, and examples thereof include fatty acid monoglycerides, fatty acid diglycerides, fatty acid triglycerides, propylene glycol fatty acid esters, sucrose fatty acid esters, polyglycerin fatty acid esters, lecithin, processed starch, sorbitan fatty acid esters, quillai extract, gum arabic, tragacanth gum, guar gum, karaya gum, xanthane gum, pectin, alginic acid and salts thereof, carrageenan, gelatin, and casein.

Among these emulsifiers, in particular, hydrophilic surfactants having HLB of 8 or more are preferred, and in the case, the emulsifier is mixed in the aqueous phase. Specifically, there are mentioned polyglycerin fatty acid esters, sorbitan fatty acid esters, sucrose fatty acid esters, and glycerin fatty acid esters. Examples of the polyglycerin fatty acid esters include esters of a polyglycerin having a mean polymerization degree of 3 or more and a fatty acid having 8 or more carbon atoms, such as decaglycerin monooleate, decaglycerin monostearate, decaglycerin monopalmitate, and decaglycerin monomyristate, having HLB or 8 or more, preferably falling within a range of 8 to 14. In the case where a polyglycerin fatty acid ester having HLB or 8 or more is used, in general, small emulsified particles having a uniform particle size can be readily prepared, and the emulsion composition containing the ester of the type is stable and, when added to drink, tends to weakly provide a separation phenomenon such as precipitation or oil separation.

The content of the polyglycerin fatty acid ester may be generally within a range of 0.05 parts by mass to 0.5 parts by mass relative to 1 part by mass of the oily phase, preferably 0.15 parts by mass to 0.3 parts by mass.

One embodiment of a method for preparing the emulsion composition of the present invention is exemplified as follows. First, a raw material containing (A) a menthyl ether represented by the formula (1) is mixed to prepare 1 part by mass of an oily phase. Apart from this, about 2 to about 50 parts by mass of a solution (aqueous phase) is prepared by mixing and dissolving (B) water, (C) one or more selected from saccharides, monoalcohols or polyalcohols and (D) an emulsifier (the resultant aqueous phase has a water content of about 0.5% by mass to about 10% by mass), then the oily phase and the aqueous phase are mixed, and emulsified using a homomixer, a colloid mill, a high-pressure homogenizer or the like to give an extremely fine and stable emulsion composition having a particle size of about 0.2 μm to about 2 μm.

The emulsion composition may contain the menthyl ether represented by the formula (1) in a concentration of generally 0.01% to 30% based on the mass of the emulsion composition, and, for example, the lower limit of the concentration is preferably 0.02%, more preferably 0.05%, even more preferably 0.1%, and the upper limit is preferably 10%, more preferably 5%, even more preferably 2%. These lower limit and upper limit may be combined in any desired manner to provide a preferred range of the concentration.

The powder composition of the present invention may be produced by drying the emulsion composition. Examples of the drying method include drying means of vacuum drying, spray drying, freeze drying, etc. In drying, a vehicle of dextrins, starches, natural gums, saccharides and other vehicles may be added to the emulsion composition.

In the case where the emulsion composition or the powder composition containing a menthyl ether represented by the formula (1) is used, the menthyl ether may be contained therein generally in a concentration of 0.1 ppm to 300 ppm by mass, and, for example, the lower limit is preferably 0.2 ppm, more preferably 0.5 ppm, even more preferably 1 ppm, and the upper limit is preferably 100 ppm, more preferably 50 ppm, even more preferably 20 ppm. These lower limit and upper limit may be combined in any desired manner to provide a preferred range of the concentration. When added in an amount falling within the concentration range, the emulsion composition or the powder composition can impart a somewhat woody, spicy and herbal aroma to food and drink or perfumery. To food and drink, the composition may impart a fresh and mild bitterness such as a naringin-like bitterness, and the rising of bitterness thereof is slow as compared with that of the simple substance of menthyl ethers alone.

Specific examples of food and drink to which the emulsion composition or the powder composition of the present invention may be added so as to impart flavor thereto or to improve or enhance the taste thereof include, though not limited thereto, carbonated drinks such as cola drinks, carbonated drinks with fruit juice, carbonated drinks with milk; non-alcohol drinks such as fruit juice drinks, vegetable drinks, sports drinks, honey drinks, soymilks, vitamin supplement drinks, mineral supplement drinks, nutrition supplement drinks, nourishing drinks, lactic acid bacilli drinks, and milk drinks; taste-oriented beverages such as green tee, black tea, oolong tea, herb tea, milk tea, and coffee drinks; alcohol drinks such as chu-hi (shochu mixed with soda water), cocktail drinks, low-malt beer, fruit wine, and medical drinks made from plants steeped in mirin; milk products such as butter, cheese, milk, and yogurt; desserts and admixtures for producing them, such as ice cream, lacto-ice (ice cream with milk-solids content of 3% or greater), sherbet, yogurt, pudding, jelly, and daily desserts; confectionery and admixtures such as cake mixes for producing them, such as caramels, candies, tablet candies, crackers, chewing gums, biscuits, cookies, pies, chocolates, and snacks; general foods such as bread, soup, various instant foods; and oral-care compositions such as tooth pastes.

Specific examples of perfumery to which the emulsion composition or the powder composition may be added so as to enhance the somewhat woody, spicy and herbal aroma thereof include perfume; hair-care products such as shampoo, rinse, hair cream, and pomade; makeup cosmetics such as face powder, and lip rouge; detergents for health and sanitation, such as face soaps, body soaps, laundry soaps, disinfectant detergents, and deodorant detergents; health and hygiene products such as tissue paper, and toilet paper; and aroma products such as indoor air refreshers, and car cologne.

### EXAMPLES

Hereinunder the present invention will be described more concretely with reference to Examples, but the present invention is not limited to these Examples. Unless otherwise specifically indicated, “%” in Examples is by mass.

In Examples, the crude reaction products and the purified products were analyzed using the following analytical instruments.

GC measurement: GC-2014 (by Shimadzu Corporation) and Chromatopack C-R8A (by Shimadzu Corporation)
GC column for GC measurement: GL Science's TC-1 (length 30 m, inner diameter 0.53 mm, liquid layer thickness 1.50 micrometers), GL Science's TC-1701 (length 30 m, inner diameter 0.53 mm, liquid layer thickness 1.00 micrometer)
GC/MS measurement; 5973 N (by Agilent Corporation)
Column for GC/MS measurement: GL Science's TC-1701 (length 30 m, inner diameter 0.25 mm, liquid layer thickness 0.25 micrometers)
NMR measurement: ECX-400A (by JEOL RESONANCE Corporation).

### Reference Example 1

### Preparation of 4-menthyloxy-2-butanone

L-Menthol (7.81 g, 50 mmol), dichloromethane (50.0 g) and boron trifluoride diethyl ether complex (0.71 g, 5 mmol) were put into a nitrogen-purged 100-mL flask and mixed by stirring therein, and then methyl vinyl ketone (10.51 g, 150 mmol) was added thereto and kept stirred at 20° C. for 4 hours. The reaction liquid was poured into an aqueous 5% sodium hydrogencarbonate solution (30.0 g) to stop the reaction. The organic layer was separated, then the aqueous layer was extracted twice with dichloromethane (15.0 g), and the combined organic layers were washed with saturated saline water, and dried with anhydrous magnesium sulfate. Magnesium sulfate was removed by suction filtration, and the solvent was evaporated away with a rotary evaporator. The resultant crude product (12.99 g) was distilled under reduced pressure to give 4-menthyloxy-2-butanone (reference product 1: amount of production 7.28 g, yield 64.3%, purity 99.1%).

### Physical Property Data of 4-menthyloxy-2-butanone (Reference Product 1)

Boiling point: 85˜88° C./0.1 kPa
¹H NMR (CDCl₃, 400 MHz) δ 0.74 (d, 3H, J=7.2 Hz), 0.81 (m, 1H), 0.85 (d, 3H. J=7.2 Hz), 0.89 (d, 3H, J=6.4 Hz), 0.95 (m, 1H), 1.16 (m, 1H), 1.32 (m, 1H), 1.60 (m, 2H), 2.09 (m, 2H), 2.16 (s, 3H), 2.64 (m, 2H), 3.01 (dt, 1H, J=4.0, 6.4 Hz), 3.54 (ddd, 1H, J=9.6, 6.8, 6.0 Hz), 3.84 (dt, 1H, J=9.2, 6.0 Hz).
¹³C NMR (CDCl₃, 100 MHz) δ 16.30, 20.97, 22.39, 23.41, 25.66, 30.57, 31.55, 34.60, 40.29, 44.24, 48.24, 63.51, 79.58, 207.69.

### MS (EI, 70 eV) m/z 41(29), 43(96), 55(44), 71(100), 81(44), 83(26), 87(23), 95(39), 123(18), 138(30), 141(40), 155(25), 169(1), 211(1), 226(M+, 0.2).

[α] (20° C., D-line, c=2.04 in CHCl₃)=−80.8

### Example 1

### Preparation of Emulsion Composition Containing 4-menthyloxy-2-butanone

As an oily phase, 4-menthyloxy-2-butanone (1.0 g), SAIB (9.0 g) and MCT (middle-chain fatty acid triglyceride) (9.0 g) were mixed and dissolved. On the other hand, as an aqueous phase, glycerin (66 g), ion-exchanged water (11 g) and decaglycerin monooleate (4.0 g) were mixed and dissolved. Using a homomixer MARK II (by Primix Corporation), the aqueous phase and the oily phase were stirred and mixed at 8000 rpm and emulsified for 10 minutes to prepare an O/W emulsion, which was so controlled that the 2000-fold dilution thereof with ion-exchanged water could have an absorbance at a wavelength 680 rim of 0.2 Abs (invention product 1: 4-menthyloxy-2-butanone concentration 1.0%).

### Aroma Evaluation

A 1% aqueous solution of the invention product 1 (in this description, an aqueous solution includes an aqueous dispersion prepared by adding the emulsion composition of the present invention to water) was prepared in a sample bottle. Five panelists evaluated the aroma from the bottle mouth and the aroma of a sample paper infiltrated with the 1% aqueous solution of the invention product 1 for aroma evaluation.

An average evaluation result of the 5 panelist was a slight woody and herbal aroma.

### Bitterness Evaluation

4-Menthyloxy-2-butanone was dissolved in 99.5% ethanol to prepare a 10 (w/w) % solution (reference product 2). The invention product 1 and the reference product 2 each were diluted with pure water to prepare solutions having a different concentration of 4-menthyloxy-2-butanone as in Table 1 below. Five panelists tried each solution to comprehensively evaluate the bitterness thereof just when they took each sample in the mouth and after they swallowed it. Bitterness intensity is scored by the following standards (point 0 was given to no taste of bitterness at all, points 2 were to a slight taste of bitterness, points 4 were to a somewhat taste of bitterness, points 6 were to a distinct taste of bitterness, points 8 were to a strong taste of bitterness, and points 10 were to an extremely strong taste of bitterness), and each panelist commented on the quality of the bitterness. Average evaluation results of 5 panelists are shown in Table 1 below.

TABLE 1

| | | Reference Product 2 (ethanol dilution) | | Invention Product 1 (emulsion composition) | |
|---|---|---|---|---|---|
| Concentration of | | Bitterness | | Bitterness | |
| 4-Menthyloxy-2-butanone | | Intensity | Comments | Intensity | Comments |
| 0.5 | ppm | 0.4 | No difference from water | 0.4 | No difference from water |
| 1 | ppm | 1.8 | Slight bitterness was given almost | 1.8 | The bitterness intensity was on the same level as that |
| | | | just when taken in the mouth. | | of the reference product 2 (1 ppm), but the rising of |
| | | | | | the bitterness was somewhat slow, and the bitterness |
| | | | | | is fresher and milder. The bitterness evokes an image |
| | | | | | of naringin. |
| 5 | ppm | 3.8 | Somewhat weak bitterness was given | 4.0 | The bitterness intensity was on the same level as that |
| | | | almost just when taken in the mouth. | | of the reference product 2 (5 ppm), but the rising of |
| | | | | | the bitterness was somewhat slow, and the bitterness |
| | | | | | is fresher and milder. The bitterness evokes an image |
| | | | | | of naringin. |
| 10 | ppm | 4.2 | Somewhat bitterness was given almost | 4.4 | The bitterness intensity was on the same level as that |
| | | | just when taken in the mouth. | | of the reference product 2 (10 ppm), but the rising of |
| | | | | | the bitterness was somewhat slow, and the bitterness |
| | | | | | is fresher and milder. The bitterness evokes an image |
| | | | | | of naringin. |
| 20 | ppm | 6.2 | Somewhat strong bitterness was given | 6.2 | The bitterness intensity was on the same level as that |
| | | | almost just when taken in the mouth. | | of the reference product 2 (20 ppm), but the rising of |
| | | | | | the bitterness was somewhat slow, and the bitterness |
| | | | | | is fresher and milder. The bitterness evokes an image |
| | | | | | of naringin. |
| 50 | ppm | 7.6 | Somewhat strong bitterness was given just | 7.8 | The bitterness intensity was on the same level as that |
| | | | when taken in the mouth, and somewhat | | of the reference product 2 (50 ppm), but the rising of |
| | | | sharp egumi (bitter and astringent taste) | | the bitterness was somewhat slow, and the bitterness |
| | | | was also given. | | is fresher and milder. The bitterness evokes an image |
| | | | | | of naringin. |
| 100 | ppm | 8.2 | Strong bitterness was given just when | 8.4 | The bitterness intensity was on the same level as that |
| | | | taken in the mouth, and sharp egumi | | of the reference product 2 (100 ppm), but the rising of |
| | | | (bitter and astringent taste) was | | the bitterness was somewhat slow, and the bitterness |
| | | | also given. | | is fresher and milder. The bitterness evokes an image |
| | | | | | of naringin. |
| 200 | ppm | 9.2 | Extremely strong bitterness was given just | 9.2 | The bitterness intensity was on the same level as that |
| | | | when taken in the mouth, and sharp egumi | | of the reference product 2 (200 ppm), but the rising of |
| | | | (bitter and astringent taste) was also given. | | the bitterness was somewhat slow, and the bitterness |
| | | | | | is fresher and milder. The bitterness evokes an image |
| | | | | | of naringin. |

As shown in the above Table 1, all of the ethanol dilutions and the emulsion compositions of the aqueous 4-menthyloxy-2-butanone solution were evaluated to give bitterness in a range of 1 ppm to 200 ppm. In comparison between the case where the emulsion composition was diluted with water and the case where the ethanol solution was diluted with water, there was little difference in the bitterness intensity between the aqueous 4-menthyloxy-2-butanone solutions having the same concentration. However, the emulsion composition diluted with water had a lower rising of bitterness than the ethanol solution diluted with water and the former had a fresher and milder bitterness than the latter. The bitterness of the emulsion composition was evaluated to evoke the bitterness of naringin.

### Example 2

### Preparation of Emulsion Composition Containing 4-menthyloxy-2-butanone

As an aqueous phase, glycerin (81 g), ion-exchanged water (14 g) and decaglycerin monooleate (4.0 g) were mixed and dissolved. The aqueous phase was mixed with 4-menthyloxy-2-butanone (1.0 g) by stirring with a homomixer MARK II (by Primix Corporation) at 8000 rpm, and emulsified for 10 minutes to prepare an O/W emulsion, which was so controlled that the 2000-fold dilution thereof with ion-exchanged water could have an absorbance at a wavelength 680 rim of 0.2 Abs (invention product 2: 4-menthyloxy-2-butanone concentration 1.0%).

### Example 3

### Preparation of Emulsion Composition Containing 4-menthyloxy-2-butanone and Edible Oil or Fat (2)

As an oily phase, 4-menthyloxy-2-butanone (1.0 g), SAIB (17.5 g) and MCT (middle-chain fatty acid triglyceride: edible oil or fat) (17.5 g) were mixed and dissolved. On the other hand, as an aqueous phase, glycerin (50 g), ion-exchanged water (8 g) and decaglycerin monooleate (6.0 g) were mixed and dissolved. Using a homomixer MARK II (by Primix Corporation), the aqueous phase and the oily phase were stirred and mixed at 8000 rpm and emulsified for 10 minutes to prepare an O/W emulsion, which was so controlled that the 2000-fold dilution thereof with ion-exchanged water could have an absorbance at a wavelength 680 nm of 0.2 Abs (invention product 3: 4-menthyloxy-2-butanone concentration 1.0%).

### Bitterness Evaluation

The invention product 1, the reference product 2, the invention product 2 and the invention product 3 were separately diluted with pure water to prepare dilutions each having a 4-menthyloxy-2-butanone concentration of 10 ppm. Five panelists tried these solutions to comparatively evaluate the rising of bitterness thereof and the bitterness substantivity just when they took each sample in the mouth and after they swallowed it. Average evaluation results are shown in Table 2 below.

TABLE 2

| | Concentration of | | |
|---|---|---|---|
| | 4-Menthyloxy-2-butanone | Contents | Organoleptic Evaluation |
| Reference | 10 ppm | ethanol solution | Just after taken in the mouth, bitterness was |
| Product 2 | | | given, and after swallowed, bitterness |
| | | | immediately disappeared. |
| Invention | 10 ppm | emulsion with no | After taken in the mouth, fresh and mild |
| Product 2 | | edible oil or fat | bitterness was given slightly later, and even |
| | | | after swallowed, the bitterness lasted for a |
| | | | while. |
| Invention | 10 ppm | emulsion with oily | After taken in the mouth, fresh and mild |
| Product 1 | | phase 19% | bitterness was given somewhat later, and |
| | | (edible oil or fat | even after swallowed, the bitterness lasted |
| | | 9%) | for a while, and the duration time was |
| | | | somewhat longer than that of the invention |
| | | | product 2. |
| Invention | 10 ppm | emulsion with oily | After taken in the mouth, fresh and mild |
| Product 3 | | phase 36% | bitterness was given considerably later, and |
| | | (edible oil or fat | even after swallowed, the bitterness lasted |
| | | 17.5%) | for a while, and the duration time was |
| | | | somewhat longer than that of the invention |
| | | | product 1. |

As shown in the above Table 2, the duration time of the bitterness was recognized to be longer with the increase in the edible oil or fat content in the emulsion compositions

### Reference Example 2

### Preparation of 2-methyl-4-menthyloxy-2-butanol

A 200-mL flask equipped with a thermometer and a dropping funnel was purged with nitrogen, and then tetrahydrofuran (dried with Molecular Sieves 5A, 50 mL) and a 3.0 M tetrahydrofuran solution of methylmagnesium chloride (21.7 mL, 65 mmol) were put thereinto, and cooled in a water bath. A solution prepared by dissolving 4-menthyloxy-2-butanone (11.32 g, 50 mmol) in tetrahydrofuran (50 mL) was dropwise added thereto via the dropping funnel at a speed at which the inner temperature could be kept at 30° C. or lower. After the addition, this was stirred as such at room temperature for 3 hours, and then the reaction liquid was put into an aqueous 25% ammonium chloride solution (100 g), and separated into an organic phase and an aqueous phase through a reparatory funnel. The aqueous phase was extracted twice with t-butyl methyl ether (30 g), and then the combined organic phases were washed with saturated saline water. This was dried with anhydrous magnesium sulfate, and then the solvent was evaporated away with a rotary evaporator. A small amount of sodium carbonate was added to the resultant crude product (12.54 g) and then distilled under reduced pressure to give 2-methyl-4-menthyloxy-2-butanol (reference product 3: amount of production 10.25 g, yield 84.6%, purity 98.2%).

### Physical Property Data of 2-methyl-4-menthyloxy-2-butanol (Reference Product 3)

Boiling point: 87° C./0.1 kPa
¹H NMR (CDCl₃, 400 MHz) δ 0.76 (d, 3H, J=6.8 Hz), 0.79-0.88 (m, 2H), 0.86 (d, 3H, J=6.8 Hz), 0.90 (d, 3H, J=6.8 Hz), 0.96 (m, 1H), 1.18 (m, 1H), 1.22 (s, 3H), 1.22 (s, 3H), 1.33 (m, 1H), 1.61 (m, 2H), 1.69 (ddd, 1H, 1=14.4, 6.8, 4.4 Hz), 1.77 (ddd, 1H, J=14.4, 7.6, 4.4 Hz), 2.13 (m, 2H), 3.03 (dt, 1H, J=4.4, 10.8 Hz), 3.50 (ddd, 1H, J=9.2, 6.8, 4.4 Hz), 3.68 (s, 1H), 3.89 (ddd, 1H, J=9.2, 7.6, 4.4 Hz).
¹³C NMR (CDCl₃, 100 MHz) δ 16.13, 21.03, 22.37, 23.25, 25.77, 29.07, 29.44, 31.57, 34.53, 40.10, 41.68, 48.23, 65.71, 70.49, 79.89.

### MS (EI, 70 eV) m/z 41(63), 43(59), 55(73), 57(49), 59(55), 67(20), 69(100), 71(90), 81(50), 83(96), 87(21), 89(23), 95(37), 97(22), 101(23), 123(17), 138(39), 139(55), 155(17), 157(22), 167(1), 181(1), 224(1), 227(1), 242 (M+, 0.1).

[α] (20° C., D-line, c=2.05 in CHCl₃)=−85.4.

### Example 4

### Preparation of Emulsion Composition Containing 2-methyl-4 -menthyloxy-2-butanol

As an oily phase, 2-methyl-4-menthyloxy-2-butanol (1.0 g), SAIB (9.0 g) and MCT (middle-chain fatty acid triglyceride) (9.0 g) were mixed and dissolved. As an aqueous phase, glycerin (66 g), ion-exchanged water (11 g) and decaglycerin monooleate (4.0 g) were mixed and dissolved. Using a homomixer MARK II (by Primix Corporation), both liquid were stirred and mixed at 8000 rpm and emulsified for 10 minutes to prepare an O/W emulsion, which was so controlled that the 2000-fold dilution thereof with ion-exchanged water could have an absorbance at a wavelength 680 rim of 0.2 Abs (invention product 4: 2-methyl-4-menthyloxy-2-butanol concentration 1.0%).

### Aroma Evaluation

A 1% aqueous solution of the invention product 4 was prepared in a sample bottle. Five panelists evaluated the aroma from the bottle mouth and the aroma of a sample paper infiltrated with the 1% aqueous solution of the invention product 4 for aroma evaluation.

An average evaluation result of the 5 panelist was a spicy and herbal aroma.

### Bitterness Evaluation

2-Methyl-4-menthyloxy-2-butanol was dissolved in 99.5% ethanol to prepare a 10 (w/w) % solution (reference product 4). The invention product 4 and the reference product 4 each were diluted with pure water to prepare solutions having a different concentration of 2-methyl-4-menthyloxy-2-butanol as in Table 3 below. Five panelists tried each solution to comprehensively evaluate the bitterness thereof just when they took each sample in the mouth and after they swallowed it. Bitterness intensity is scored by the following standards (point 0 was given to no taste of bitterness at all, points 2 were to a slight taste of bitterness, points 4 were to a somewhat taste of bitterness, points 6 were to a distinct taste of bitterness, points 8 were to a strong taste of bitterness, and points 10 were to an extremely strong taste of bitterness), and each panelist commented on the quality of the bitterness. Average evaluation results of 5 panelists are shown in Table 3 below.

TABLE 3

| | | Reference Product 4 (ethanol dilution) | | Invention Product 4 (emulsion composition) | |
|---|---|---|---|---|---|
| Concentration of | | Bitterness | | Bitterness | |
| 2-Methyl-4-menthyloxy-2-butanol | | Intensity | Comments | Intensity | Comments |
| 0.2 | ppm | 0.4 | No difference from water | 0.2 | No difference from water |
| 0.5 | ppm | 1.8 | Slight bitterness was given almost | 1.6 | The bitterness intensity was on the same level as that |
| | | | just when taken in the mouth. | | of the reference product 4 (0.5 ppm), but the rising of |
| | | | | | the bitterness was somewhat slow, and the bitterness |
| | | | | | is fresher and milder. The bitterness evokes an image |
| | | | | | of naringin. |
| 2 | ppm | 3.8 | Somewhat weak bitterness was | 3.6 | The bitterness intensity was on the same level as that |
| | | | given almost just when taken in | | of the reference product 4 (2 ppm), but the rising of |
| | | | the mouth. | | the bitterness was somewhat slow, and the bitterness |
| | | | | | is fresher and milder. The bitterness evokes an image |
| | | | | | of naringin. |
| 5 | ppm | 4.2 | Somewhat bitterness was given | 4.0 | The bitterness intensity was on the same level as that |
| | | | almost just when taken in | | of the reference product 4 (5 ppm), but the rising of |
| | | | the mouth. | | the bitterness was somewhat slow, andthe bitterness |
| | | | | | is fresher and milder. The bitterness evokes an image |
| | | | | | of naringin. |
| 10 | ppm | 6.0 | Somewhat strong bitterness was | 5.8 | The bitterness intensity was on the same level as that |
| | | | given almost just when taken in | | of the reference product 4 (10 ppm), but the rising of |
| | | | the mouth. | | the bitterness was somewhat slow, and the bitterness |
| | | | | | is fresher and milder. The bitterness evokes an image |
| | | | | | of naringin. |
| 20 | ppm | 7.6 | Somewhat strong bitterness was | 7.6 | The bitterness intensity was on the same level as that |
| | | | given just when taken in the | | of the reference product 4 (20 ppm), but the rising of |
| | | | mouth, and somewhat sharp egumi | | the bitterness was somewhat slow, and the bitterness |
| | | | (bitter and astringent taste) was | | is fresher and milder. The bitterness evokes an image |
| | | | also given. | | of naringin. |
| 50 | ppm | 8.2 | Strong bitterness was given | 8.0 | The bitterness intensity was on the same level as that |
| | | | just when taken in the mouth, | | of the reference product 4 (50 ppm), but the rising of |
| | | | and sharp egumi (bitter and | | the bitterness was somewhat slow, and the bitterness |
| | | | astringent taste) was also given. | | is fresher and milder. The bitterness evokes an image |
| | | | | | of naringin. |
| 100 | ppm | 9.0 | Extremely strong bitterness was | 8.8 | The bitterness intensity was on the same level as that |
| | | | given just when taken in the | | of the reference product 4 (100 ppm), but the rising of |
| | | | mouth, and sharp egumi (bitter and | | the bitterness was somewhat slow, and the bitterness |
| | | | astringent taste) was also given. | | is fresher and milder. The bitterness evokes an image |
| | | | | | of naringin. |

As shown in the above Table 3, all of the ethanol dilutions and the emulsion compositions of the aqueous 2-methyl-4-menthyloxy-2-butanol solution were evaluated to give bitterness in a range of 0.5 ppm to 100 ppm. In comparison between the case where the emulsion composition was diluted with water and the case where the ethanol solution was diluted with water, there was little difference in the bitterness intensity between the aqueous 2-methyl-4-menthyloxy-2-butanol solutions having the same concentration. However, the emulsion composition diluted with water had a lower rising of bitterness than the ethanol solution diluted with water and the former had a fresher and milder bitterness than the latter. The bitterness of the emulsion composition was evaluated to evoke the bitterness of naringin.

### Example 5

### Addition Effect to Beer-Taste Drink

0.1% of the invention product 1 (4-menthyloxy-2-butanone concentration 10 ppm) or 0.1% of the invention product 4 (2-methyl-4-menthyloxy-2-butanol concentration 10 ppm) was added to a commercial beer-taste drink, and organoleptically evaluated by 5 panelists in point of bitterness, filling sensation in drinking, smooth sensation in swallowing, sharp taste, and after taste. Average organoleptic evaluation results are as mentioned below.

The beer-taste drink added with the invention product 1 had a better bitterness than the additive-free drink, and in addition, the former provided a remarkable effect in point of the smooth sensation in swallowing and the sharp taste. Regarding the added drink, the filling sensation in drinking increased a little, and the after taste was somewhat improved.

The beer-taste drink added with the invention product 4 had a better bitterness than the additive-free drink, and in addition, the former provided a remarkable effect in point of the smooth sensation in swallowing and the sharp taste. Regarding the added drink, the filling sensation in drinking increased a little, and the after taste was somewhat improved.

### Example 6

### Emulsion Composition of Orange-like Compounded Flavor Composition

Orange-like compounded flavor compositions of Reference Products 5 to 7 were prepared according to the following Table 4.

TABLE 4
Formulation of Orange-like Compounded
Flavor Composition (% by mass)

| | Reference | Reference | Reference |
|---|---|---|---|
| | Product 5 | Product 6 | Product 7 |
| Bitter Orange Oil | 70 | 70 | 70 |
| Petitgrain Oil | 5 | 5 | 5 |
| Neroli Oil | 5 | 5 | 5 |
| Lavandulyl Acetate | 1 | 1 | 1 |
| Citral Dimethyl Acetal | 2 | 2 | 2 |
| Prenol | 1 | 1 | 1 |
| Valencene | 0.5 | 0.5 | 0.5 |
| Tetrahydromyrcenol | 0.2 | 0.2 | 0.2 |
| Reference Product 1 | — | 50 | — |
| Reference Product 3 | — | — | 50 |
| SAIB | 400 | 400 | 400 |
| Middle Chain Saturated Fatty Acid | 515.3 | 465.3 | 465.3 |
| Triglyceride | | | |
| Total | 1000 | 1000 | 1000 |

As an oily phase, 100 g of the orange-like compounded flavor composition of the above Table 4 (reference product 5, reference product 6 or reference product 7) was prepared, and as an aqueous phase, glycerin (312.5 g), ion-exchanged water (65 g) and decaglycerin monooleate (22.5 g) were mixed and dissolved. Using a homomixer MARK II (by Primix Corporation), both liquid were stirred and mixed at 8000 rpm and emulsified for 10 minutes to prepare an O/W emulsion of an orange-like compounded flavor composition, which was so controlled that the 2000-fold dilution thereof with ion-exchanged water could have an absorbance at a wavelength 680 nm of 0.2 Abs. The emulsion composition containing the reference product 5 was a comparative product 1, the emulsion composition containing the reference product 6 was an invention product 5, and the emulsion composition containing the reference product 7 was an invention product 6.

The emulsion compositions of orange-like compounded flavor compositions (comparative product 1, invention product 5 and invention product 6) were separately added to a drink base formulated as in the following Table 5 to prepare orange fruit drinks.

TABLE 5
Formulation of Orange Juice Drink (30% juice)

| | | |
|---|---|---|
| High-Fructose Corn Syrup | 300 | parts by mass |
| Citric Acid (crystal) | 15 | parts by mass |
| Vitamin C | 1 | part by mass |
| Valencia Orange Juice 1/5 | 60 | parts by mass |
| Invention Product 5 or 6, or Comparative | 1 | part by mass |
| Product 1 | | |
| Soft Water | 623 | parts by mass |
| Total | 1000 | parts by mass |

For flavor evaluation, 5 expert panelists were chosen, and they tried the orange juice drinks added with the comparative product 1, the invention product 5 or the invention product 6, and evaluated them in point of the bitterness and the flavor evaluation items of fruity flesh sensation, freshness sensation, fruit skin sensation and ripe fruit sensation. In evaluation, the flavor of each sample was comprehensively evaluated based on the flavor of the comparative product 1 just when the fruit drink was taken into the mouth and after it was swallowed down. The bitterness standard is as follows. A score was given to sensation of no bitterness at all. A score +/− was given to sensation of no definite bitterness. A score + was given to sensation of bitterness. A score ++ was given to sensation of strong bitterness. A score +++ was given to sensation of too strong bitterness. The flavor evaluation in drinking in point of fruity flesh sensation, freshness sensation, fruit skin sensation and ripe fruit sensation is based on the following standard. A score − was given to no sensation of flavor at all. A score +/− was given to no definite sensation of flavor. A score + was given to some sensation of flavor. A score ++ was given to strong sensation of flavor. Average flavor evaluation results are shown in the following Table 6 and in this, the panelists' comments on their flavor evaluation are shown.

TABLE 6
Evaluation of Flavor of Orange Juice Drinks

| Emulsion | Flavor Evaluation | | | | | |
|---|---|---|---|---|---|---|
| Composition | | Fruity Flesh | Freshness | Fruit Skin | Ripe Fruit | |
| Added | Bitterness | Sensation | Sensation | Sensation | Sensation | Comments |
| Comparative | − | + | +/− | − | − | |
| Product 1 | | | | | | |
| Invention | + | + | +/− | ++ | − | Orange fruit skin sensation |
| Product 5 | | | | | | was given, and the natural |
| | | | | | | feeling was emphasized. |
| Invention | ++ | + | +/− | ++ | − | Orange fruit skin bitterness |
| Product 6 | | | | | | was given, and the natural |
| | | | | | | feeling was emphasized |
| | | | | | | more. |

As shown in the above Table 6, the orange juice drink added with the invention product 5 or 6 reproduced a native-like orange flavor. Specifically, the drink was evaluated to have an orange fruit skin sensation and to have a flavor that could evoke the flavor in eating a flesh raw orange.

### Example 7

### Emulsion Composition of Mint-like Compounded Flavor Composition

Mint-like compounded flavor compositions (mint flavors) of Reference Products 8 to 10 were prepared according to the following Table 7.

TABLE 7
Formulation of Mint-like Compounded
Flavor Composition (% by mass)

| | Reference | Reference | Reference |
|---|---|---|---|
| | Product 8 | Product 9 | Product 10 |
| Peppermint Essential Oil | 98 | 98 | 98 |
| Eucalyptus Essential Oil | 10 | 10 | 10 |
| Lemon Essential Oil | 8 | 8 | 8 |
| L-Menthol | 78 | 78 | 78 |
| Menthyl 3-Hydroxybutyrate | 20 | 20 | 20 |
| Reference Product 1 | — | 20 | — |
| Reference Product 3 | — | — | 20 |
| Middle-Chain Saturated Fatty Acid | 786 | 766 | 766 |
| Triglyceride | | | |
| Total | 1000 | 1000 | 1000 |

As an oily phase, 100 g of the mint-like compounded flavor composition of the above Table 7 (reference product 8, reference product 9 or reference product 10) was prepared, and as an aqueous phase, glycerin (312.5 g), ion-exchanged water (65 g) and decaglycerin monooleate (22.5 g) were mixed and dissolved. Using a homomixer MARK II (by Primix Corporation), both liquid were stirred and mixed at 8000 rpm and emulsified for 10 minutes to prepare an O/W emulsion of a mint-like compounded flavor composition. The emulsion composition containing the reference product 8 was a comparative product 2, the emulsion composition containing the reference product 9 was an invention product 7, and the emulsion composition containing the reference product 10 was an invention product 8.

The emulsion compositions of mint-like compounded flavor compositions (invention product 7 or 8, or comparative product 2) were separately added to a gum base formulated as in the following Table 8 to prepare mint-flavor chewing gums by a common procedure.

TABLE 8
Formulation of Mint-Flavor Chewing Gum: % by mass

| | | |
|---|---|---|
| Gum Base | 25 | parts by mass |
| Sugar | 66 | parts by mass |
| Reducing Sugar Liquid | 7 | parts by mass |
| Propylene Glycol | 1 | part by mass |
| Invention Product 7 or 8 or Comparative | 1 | part by mass |
| Product 2 | | |
| Total | 100 | parts by mass |

For flavor evaluation, 5 expert panelists were chosen, and they tried the mint-flavor chewing gums added with the invention product 7 or 8 or the comparative product 2 by chewing, and evaluated them in point of the bitterness, the fresh sensation, the herbal sensation, the native-like sensation and the chemical-like sensation of the mint-flavor chewing gums for flavor evaluation thereof. Based on the sample added with the comparative product 2, the samples were comprehensively evaluated in point of the flavor thereof just when the panelists began to chew each sample and in 10 minutes after the start of chewing it. The bitterness standard is as follows. A score − was given to sensation of no bitterness at all. A score +/− was given to sensation of no definite bitterness. A score + was given to sensation of bitterness. A score ++ was given to sensation of strong bitterness. A score +++ was given to sensation of too strong bitterness. The flavor evaluation in chewing in point of the fresh sensation, the herbal sensation, the native-like sensation and the chemical-like sensation is based on the following standard. A score − was given to no sensation of flavor at all. A score +/− was given to no definite sensation of flavor. A score + was given to some sensation of flavor. A score ++ was given to strong sensation of flavor. Average flavor evaluation results are shown in the following Table 9.

TABLE 9
Evaluation of Flavor of Mint-like Chewing Gums

| Emulsion | Flavor Evaluation | | | | | |
|---|---|---|---|---|---|---|
| Composition | | Fresh | Herbal | Native-like | Chemical-like | |
| Added | Bitterness | Sensation | Sensation | Sensation | sensation | Comments |
| Comparative | +/− | ++ | +/− | − | + | The fresh sensation was strong, |
| Product 2 | | | | | | but the bitterness and the herbal |
| | | | | | | sensation were weak. This gave |
| | | | | | | a chemical-like sensation and was |
| | | | | | | poor in native-like sensation. |
| Invention | + | + | + | ++ | − | A fresh bitterness and a pleasant |
| Product 7 | | | | | | fresh sensation lasted long. |
| Invention | ++ | + | + | ++ | − | This gave a pleasant bitterness |
| Product 8 | | | | | | and a strong mint-like flavor, both |
| | | | | | | of which lasted long. |

As shown in the above Table 9, the mint-flavor chewing gum added with the comparative product 2 had a strong fresh sensation but had a weak bitterness and a weak herbal sensation. In addition, it had a chemical-like sensation and was poor in a native-like sensation. As opposed to this, in evaluation of the mint-flavor chewing gum added with the invention product 7 or 8, the fresh bitterness and the mint-like fresh sensation were combined to present a native-like sensation, and the chemical-like sensation like that of the comparative product 2 was suppressed.

While the present invention has been described in detail and with reference to specific embodiments thereof, it will be apparent to one skilled in the art that various changes and modifications can be made therein without departing from the spirit and scope thereof.

The present disclosure relates to the subject matter contained in International Application No. PCT/JP2017/009371, filed on Mar. 9, 2017 and Japanese Patent Application No. 2016-074574 filed on Apr. 1, 2016, the contents of which are expressly incorporated herein by reference in their entirety. All the publications referred to in the present specification are also expressly incorporated herein by reference in their entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims.

What is claimed is:

1. An emulsion composition comprising the following (A) to (D):
(A) A menthyl ether represented by the following formula (1): 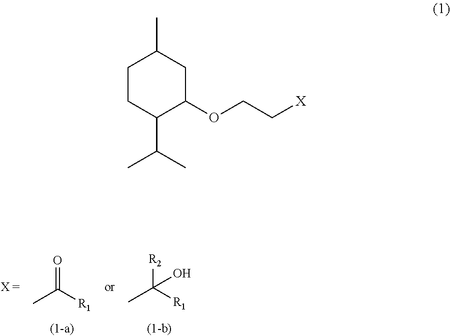
wherein, in the formula (1), X represents a partial structural formula (1-a) or (1-b), and R₁ and R₂ each represent a methyl group, an ethyl group, a propyl group or an isopropyl group,
(B) Water,
(C) One or more selected from saccharides, monoalcohols or polyalcohols,
(D) An emulsifier.

2. The emulsion composition according to claim 1, further comprising (E) an edible oil or fat.

3. The emulsion composition according to claim 1, wherein the menthyl ether is 2-methyl-4-menthyloxy-2-butanol represented by the following formula (2):

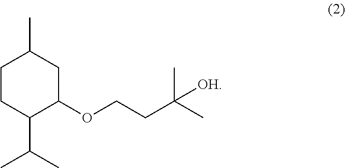 [SMILES: CC1CCC(C(C)C)C(OCCC(C)(C)O)C1]

4. A powder composition prepared by drying the emulsion composition of claim 1.

5. Food and drink comprising the emulsion composition of claim 1.

6. Perfumery comprising the emulsion composition of claim 1.

7. A flavor-imparting, or flavor-modulating method for food and drink or perfumery, which comprises adding thereto the emulsion composition of claim 1.

8. A bitterness imparting method for food and drink, which comprises adding thereto the emulsion composition of claim 1.
